(19) United States
(12) Patent Application Publication
(10) Pub. No.: US 2008/0197111 A1
(43) Pub. Date: Aug. 21, 2008

(54) METHOD FOR FABRICATING FLASH MEMORY DEVICE

(75) Inventor: Tae-Woo JUNG, Ichon-shi (KR)

Correspondence Address: LOWE HAUPTMAN HAM & BERNER, LLP, 1700 DIAGONAL ROAD, SUITE 300, ALEXANDRIA, VA, 22314, US

(73) Assignee: HYNIX SEMICONDUCTOR INC., Ichon-shi (KR)

(21) Appl. No.: 11/951,651

(22) Filed: Dec. 6, 2007

(30) Foreign Application Priority Data
Feb. 21, 2007 (KR) 10-2007-0017366

(51) Int. Cl. B44C 1/22

(52) U.S. Cl. 216/74

(57) ABSTRACT

A method for fabricating a nonvolatile memory device includes forming a gate stack over a substrate, the gate stack including an aluminum oxide layer as a dielectric layer, and etching the aluminum oxide layer of the gate stack using a gas containing silicon.

### CROSS-REFERENCE TO RELATED APPLICATIONS

The present invention claims priority of Korean patent application number 2007-0017366, filed on Feb. 21, 2007, which is incorporated by reference in its entirety.

### BACKGROUND OF THE INVENTION

The present invention relates to a method for fabricating a nonvolatile memory device, and more particularly, to a method for fabricating a nonvolatile memory device employing an aluminum oxide (Al₂O₃) layer as a dielectric layer.

Typical dynamic random access memory (DRAM) devices lose stored data if power is not supplied. In typical DRAM devices, a transistor acts as a switch component and a capacitor serves as a data storage component. Hence, the DRAM device is a kind of volatile memory devices in which internal data are lost when power supply is disconnected.

To overcome such a disadvantage of the DRAM, studies are being conducted on nonvolatile memory devices realizing both high-speed writing capability of the DRAM and nonvolatile properties into one DRAM.

That is, a nonvolatile memory device has been developed to have a transistor which can store data therein so that data stored in a capacitor can be transferred to and stored at the transistor when the DRAM is powered off, thus exhibiting similar properties as those of flash memory devices.

As it is well known, the nonvolatile memory device has a gate stack configured with a floating gate structure and a single gate structure.

The floating gate structure and the single gate structure employ a high-K oxide layer, e.g., an Al₂O₃ layer, as a dielectric layer. Typically, the etch of the Al₂O₃ layer is performed using a gas-mixture including a trichloroborane (BCl₃) gas and a methane (CH₄) gas in which the BCl₃ gas is used as main gas. In the case of using the BCl₃ gas, however, an etch selectivity ratio of the Al₂O₃ layer to an underlying layer such as a polysilicon layer and a nitride layer is approximately 3:1 at most.

Chemical reaction between the BCl₃ gas and the aluminum oxide layer will be expressed as the following Formula 1.

BCl₃+Al₂O₃→AlCl₃(↑)+B—O (Formula 1)

From Formula 1, it can be appreciated that the BCl₃ gas reacts with the Al₂O₃ layer to thereby generate an aluminum chloride (AlCl₃) gas and a boron oxide (B—O). At this time, the product of the AlCl₃ is volatilized but the product of the B—O is left to impede the etch of the Al₂O₃ layer, thus causing the etch selectivity ratio to an underlying layer to be lowered.

To form a gate stack with a vertical profile, the Al₂O₃ layer must also be formed to have a vertical profile. However, the BCl₃ gas has a low etch selectivity ratio to the underlying layer, which makes it difficult to sufficiently perform an over-etch necessary to obtain a vertical profile, making it difficult to etch the aluminum oxide layer to have a substantially vertical profile at an angle greater than 87°.

Accordingly, the etched aluminum oxide layer becomes to have a slanted profile after all, which may cause defects during a subsequent ion implantation process which uses the gate stack as a self-aligning mask to implant a dopant into the substrate.

### SUMMARY OF THE INVENTION

Embodiments of the present invention are directed to provide a method for fabricating a nonvolatile memory device that can etch the aluminum oxide layer to have a substantially vertical profile.

In accordance with an aspect of the present invention, there is provided a method for fabricating a nonvolatile memory device. The method includes forming a gate stack over a substrate, the gate stack including an aluminum oxide layer as a dielectric layer, and etching the aluminum oxide layer of the gate stack using a gas containing silicon.

### BRIEF DESCRIPTION OF THE DRAWINGS

FIGS. 1A to 1C are cross-sectional views of a method for fabricating a nonvolatile memory device in accordance with a first embodiment of the present invention.

FIG. 2 is a cross-sectional view of a method for fabricating a nonvolatile memory device in accordance with a second embodiment of the present invention.

FIG. 3 is a cross-sectional view of a method for fabricating a nonvolatile memory device in accordance with a third embodiment of the present invention.

### DESCRIPTION OF SPECIFIC EMBODIMENTS

Embodiments of the present invention relate to a method for fabricating a nonvolatile memory device.

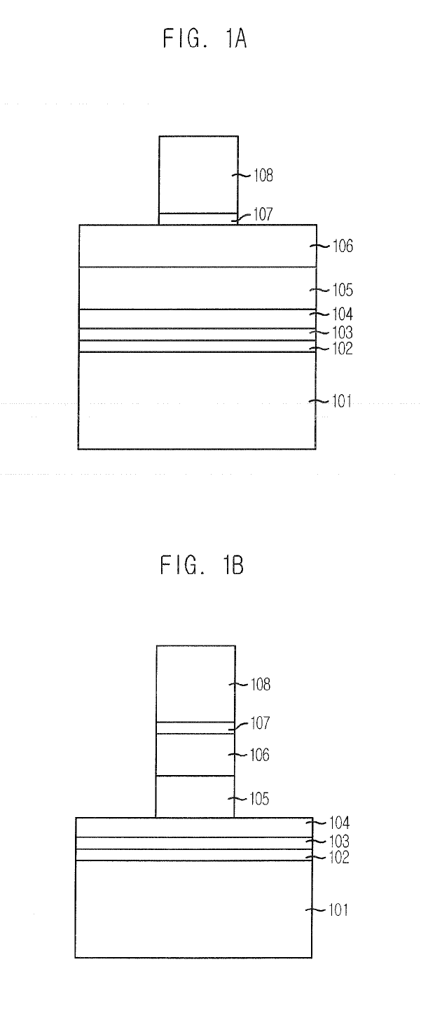

FIGS. 1A to 1C are cross-sectional views of a method for fabricating a nonvolatile memory device in accordance with a first preferred embodiment of the present invention. In the first embodiment of the present invention, a nonvolatile memory device having a silicon-oxide-nitride-oxide-silicon (SONOS) structure will be exemplarily described below.

Referring to FIG. 1A, a tunnel oxide layer 102, a nitride layer 103, an aluminum oxide layer 104, a polysilicon layer 105 and a tungsten silicide layer 106 are formed over a substrate 101 so as to form a SONOS structure.

Here, the substrate 101 may be a semiconductor substrate undergoing processes for a nonvolatile memory device. The nitride layer 103 is used for storing charges in the SONOS structure. The polysilicon layer 105 and the tungsten layer 106 are used for a gate electrode. The tunnel oxide layer 102 may be formed with a thickness ranging from approximately 60 Å to approximately 80 Å, the nitride layer 103 may be formed with a thickness ranging from approximately 50 Å to approximately 70 Å, the aluminum oxide layer 104 may be formed with a thickness ranging from approximately 100 Å to approximately 150 Å, the polysilicon layer 105 may be formed with a thickness ranging from approximately 600 Å to approximately 800 Å, and the tungsten silicide layer 106 may be formed with a thickness ranging from approximately 1,000 Å to approximately 1,200 Å.

A patterned silicon oxynitride (SiON) layer 107 and a patterned hard mask oxide layer 108 are formed over the tungsten silicide layer 106. Here, the SiON layer 107 may be formed with a thickness ranging from approximately 300 Å to approximately 500 Å, and the hard mask oxide layer 108 may be formed with a thickness ranging from approximately 1,000 Å to approximately 1,500 Å.

Referring to FIG. 1B, the tungsten silicide layer 106 and the polysilicon layer 105 are etched. Referring to FIG. 5C, the aluminum oxide layer 104 is then etched. Specifically, the aluminum oxide layer 104 is etched using a gas containing silicon, for example, tetrachlorosilane (SiCl₄) gas or a gas-mixture including the SiCl₄ gas and trichloroborane (BCl₃) gas. Also, a shielding gas selected from methane (CH₄) gas, acetylene (C₂H₂) gas and a gas mixture including the CH₄ gas and the C₂H₂ gas is added into the gas containing silicon, and the aluminum oxide layer 104 is etched at a temperature of approximately 100° C. or lower. An over-etch is then performed to obtain the aluminum oxide layer 104 having a substantially vertical profile while not applying bottom power.

In this way, an etch selectivity ratio of the aluminum oxide layer 104 to an underlying layer such as a nitride layer, an oxide layer, and a polysilicon layer (in the present preferred embodiment, the nitride layer is a target underlying layer) can be maintained to approximately 5:1 or greater by using the gas containing silicon, e.g., the gas containing SiCl₄ gas, when etching the aluminum oxide layer 104. Therefore, the aluminum oxide layer 104 can be sufficiently over-etched without attacking the underlying layer, thus achieving a substantially vertical profile.

The reason why it is possible to achieve a higher etch selectivity ratio to the underlying layer in the case of using the gas containing silicon than the case of using the BCl₃ gas may be apparent from the following Formula 2.

SiCl₄+Al₂O₃→AlCl₃(↑) (Formula 2)

From Formula 2, it can be appreciated that the SiCl₄ reacts with the Al₂O₃ to generate an AlCl₃ and a silicon oxide (Si—O). At this time, the product of the AlCl₃ is volatilized and a small quantity of the Si—O is remaining. However, since the underlying layer such as nitride (Si₃N₄) layer, an oxide (SiO₂) layer and a polysilicon layer contains silicon therein, the residual Si—O is deposited on the underlying layer, leading to the increase in etch selectivity ratio. Therefore, it is possible to secure an etch selectivity ratio to the underlying layer at approximately 5:1 or greater.

Further, the BCl₃ gas has a melting point of −107° C. and a boiling point of 12.4° C. and the SiCl₄ gas has a melting point of −70° C. and a boiling point of 57.6° C., that is, the SiCl₄ gas also has the melting point and the boiling point as low as the BCl₃ gas. Since the SiCl₄ gas exists in liquid state at room temperature and has strong volatility, there is no problem in applying the SiCl₄ gas to the etch process of aluminum oxide.

The shielding gas, e.g., one selected from the CH₄ gas, the C₂H₂ gas and a gas-mixture including the CH₄ gas and the C₂H₂ gas, which is used together with the gas containing silicon during the etch of the aluminum oxide layer 104, can prevent the aluminum oxide layer 104 from being excessively etched compared to other layers.

As other gases for etching the aluminum oxide layer 104, fluorine (F)-based gas or boron (B)-based gas is not available because the fluorine-based or the boron-based gas has a very high melting point or boiling point and hence not easily volatilized. In particular, the fluorine-based gas reacts with the aluminum oxide layer 104 to generate trifluoroalumane (AlF₃) and tungsten hexafluoride (WF₆) which are not volatilized but deposited instead, thereby impeding the etch of the aluminum oxide layer 104. In the case of using the boron-based gas such as an HBr gas, residues are left and bumps may be formed.

Therefore, an etch selectivity ratio of the aluminum oxide layer 104 to an underlying layer such as a nitride layer, an oxide layer, and a polysilicon layer can be maintained to approximately 5:1 or greater by using the gas containing silicon, e.g., the gas containing the SiCl₄ gas, thus making it possible to etch the aluminum oxide layer 104 with a substantially vertical profile.

Although the first preferred embodiment has illustrated the case of etching the aluminum oxide layer used in the SONOS structure, the present invention is also applicable to a floating gate structure or a metal-Al₂O₃-nitride-oxide-silicon (MANOS) structure, which will be more fully described in second and third embodiments of the present invention.

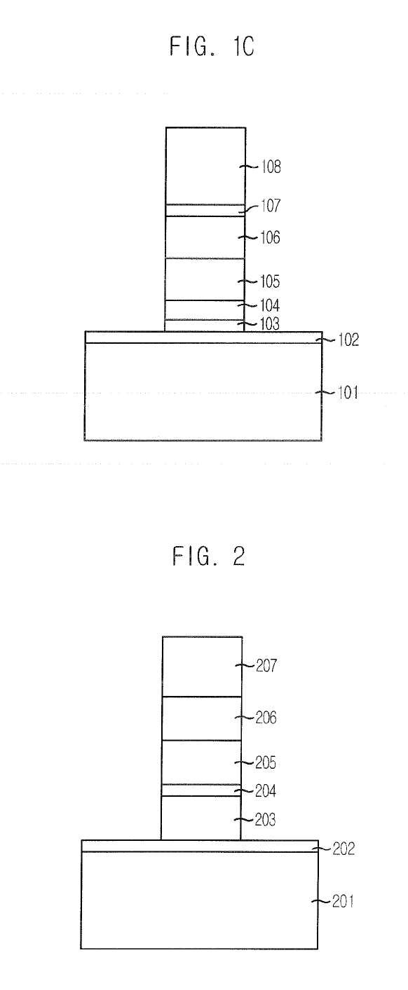

FIG. 2 is a cross-sectional view of a method for fabricating a nonvolatile memory device in accordance with a second embodiment of the present invention. In the second embodiment of the present invention, a nonvolatile memory device having a floating gate structure will be exemplarily described.

Referring to FIG. 2, a tunnel oxide layer 202 is formed over a substrate 201. A gate stack is disposed on the tunnel oxide layer 202. The gate stack includes a polysilicon layer 203 for a floating gate, an aluminum oxide layer 204 for a dielectric layer, a titanium nitride (TiN) layer 205, a tungsten (W) layer 206 and a hard mask layer 207, which are sequentially provided over the tunnel oxide layer 202. Here, the titanium nitride layer 205 and the tungsten layer 206 serve as a gate electrode. The tungsten layer 206 may include a tungsten silicide (WSix) layer.

Similarly to the first embodiment, the aluminum oxide layer 204 is etched using a gas containing silicon e.g., a gas containing SiCl₄ gas, so that an etch selectivity ratio of the aluminum oxide layer 204 to the underlying polysilicon layer 203 can be maintained to approximately 5:1 or greater, thus obtaining the gate stack with a substantially vertical profile in the second preferred embodiment.

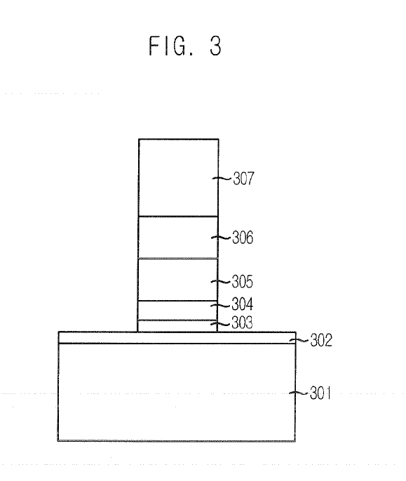

FIG. 3 is a cross-sectional view of a method for fabricating a nonvolatile memory device in accordance with a third preferred embodiment of the present invention. The nonvolatile memory device in accordance with the third preferred embodiment of the present invention has an MANOS structure.

Referring to FIG. 3, a tunnel oxide layer 302 is formed over a substrate 301. A gate stack is formed over the tunnel oxide layer 302. The gate stack includes a nitride layer 303 for charge storage, an aluminum oxide layer 304 for a dielectric layer, a titanium nitride layer 305, a tungsten layer 306 and a hard mask layer 307, which are sequentially provided over the tunnel oxide layer 302. Here, the titanium nitride layer 305 and the tungsten layer 306 serve as a gate electrode.

Alternatively, a tantalum nitride layer may be used instead of the titanium nitride layer 305. The tungsten layer 306 may include a tungsten silicide layer.

Similarly to the first embodiment, the aluminum oxide layer 304 is etched using a gas containing silicon e.g., a gas containing SiCl₄ gas, so that an etch selectivity ratio of the aluminum oxide layer 304 to the underlying nitride layer 303 can be maintained to approximately 5:1 or greater, thus obtaining the gate stack with a substantially vertical profile in the third preferred embodiment.

As described above, in accordance with the present invention, the aluminum oxide layer is etched using the gas containing silicon, e.g., the gas containing SiCl₄ gas. It is advantageous in that an etch selectivity ratio of the aluminum oxide layer to an underlying layer can be maintained to approximately 5:1 or greater, thus etching the aluminum oxide layer with a substantially vertical profile.

In accordance with the present invention, it is possible to secure a high etch selectivity ratio of an aluminum oxide layer to an underlying layer, thereby achieving a substantially vertical profile of the aluminum oxide.

Accordingly, it is possible to prevent defects during a subsequent process of ion implantation to implant a dopant into the substrate, thus increasing product yield noticeably.

While the present invention has been described with respect to the specific embodiments, it will be apparent to those skilled in the art that various changes and modifications may be made without departing from the spirit and scope of the invention as defined in the following claims.

What is claimed is:

1. A method for fabricating a nonvolatile memory device, the method comprising:
forming a gate stack over a substrate, the gate stack including an aluminum oxide layer as a dielectric layer; and
etching the aluminum oxide layer of the gate stack using a gas containing silicon.

2. The method of claim 1, wherein the gas containing silicon includes a tetrachlorosilane (SiCl₄) gas.

3. The method of claim 1, wherein the gas containing silicon includes a gas mixture including the SiCl₄ gas and trichloroborane (BCl₃) gas.

4. The method of claim 1, wherein the gate stack has an underlying layer containing silicon under the aluminum oxide layer.

5. The method of claim 4, wherein the underlying layer includes a polysilicon layer, a silicon nitride layer and a silicon oxide layer.

6. The method of claim 4, wherein the etch selectivity ratio of the aluminum oxide layer to the underlying layer is approximately 5:1 or greater.

7. The method of claim 2, wherein the gas containing silicon is added with a shielding gas.

8. The method of claim 4, wherein the shielding gas includes one selected from a group consisting of methane (CH₄) gas, acetylene (C₂H₂) gas and a gas-mixture including the CH₄ gas and the C₂H₂ gas.

9. The method of claim 1, wherein etching the aluminum oxide layer is performed at a temperature of approximately 100° C. or lower.

10. The method of claim 1, further comprising, after etching the aluminum oxide layer, performing an over-etch.

11. The method of claim 7, wherein the over-etch is performed while not applying a bottom power.

12. The method of claim 1, wherein the gate stack has a stacked structure in which an oxide layer, a polysilicon layer, the aluminum oxide layer, a titanium nitride layer, and a tungsten layer or a tungsten silicide layer are formed over the substrate.

13. The method of claim 1, wherein the gate stack has a stacked structure in which an oxide layer, a nitride layer, the aluminum oxide layer, a titanium layer or a tantalum nitride layer, and a tungsten layer or a tungsten silicide layer are formed over the substrate.
